(19) United States
(12) Patent Application Publication
(10) Pub. No.: US 2002/0033285 A1
(43) Pub. Date: Mar. 21, 2002

(54) Method of inputting information into computer device, computer device, sticker keyboard and computer device using this method

(76) Inventor: Alexei Vladimirovich Afanasiev, Novosibirsk (RU)

Correspondence Address: AFANASIEV, Aleksey, Vladimirovich, 58, Moika Embankment, Office 501, St.Petersburg, 190000, RU

(21) Appl. No.: 09/988,383

(22) Filed: Nov. 19, 2001

Related U.S. Application Data
(63) Continuation-in-part of application No. PCT/RU99/00430, filed on Nov. 11, 1999.
(60) Provisional application No. 60/136,384, filed on May 27, 1999.

(51) Int. Cl. G06K 11/06

(52) U.S. Cl. 178/18.01

(57) ABSTRACT

A convenient method of inputting information into a palmtop computer device, a sticker keyboard and a computer device with this sticker keyboard are proposed, whereby the user may alternatively input information either by writing predetermined strokes like characters and numerals in a handwriting input area, or by acting (using predetermined handwriting actions) on smaller input areas arranged on the sticker keyboard, wherein the screen space available for displaying information is not reduced and the user does not have to swing from one area of the display screen/digitizer pad to another while inputting information.

### BACKGROUND OF THE INVENTION

1. Technical Field

The present invention relates to the field of computer devices, particularly, palm-top computer devices incorporating means for inputting handwriting information.

2. Background Art

As the components required to build a computer have reduced in size, new categories of computers have emerged. One of the new categories of computers is the “palmtop” computer. A palmtop computer is a computer that is small enough to be held in the hands of the user. Most palmtop computers are used to implement various Personal Information Management applications such as an address book, a daily organiser, and an electronic notepad.

Since palmtop computers are very small, physical keyboards that historically have been used for inputting information into a computer device are generally eliminated from these type of computers and personal digital assistants, because its size and weight make it impractical to carry and use and inefficient as input devices. However, it has also been recognised that nearly all users would benefit from the ability to perform keyboard input.

One approach is to use a keyboard emulator that may be displayed on the display screen. An interactive pointing/drawing device e.g., a mouse or a conductive pen is used in this case for selecting the desired keys. Additionally, a digitizer pad may be used that responds to the user's fingers or some type of pointing/drawing device. Known are computers in which a display screen itself responds to pointing/drawing device, e.g. a pen. In other words, a display screen is combined with a digitizer pad to provide double keyboard input for such type of computers.

Keyboard emulators are widely known in the art (see, e.g., U.S. Pat. No. 5,031,119 “Split Screen Keyboard Emulator” granted to Dulaney, et.al. on Jul. 9, 1991). Pressing with a pen on any of the “virtual” keys displayed on the screen (which may be combined with a digitizer pad) results in inputting a respective character or command. Because a pen, not finger, is used for pressing the keys, the keyboard emulator may be small enough.

Further, in U.S. Pat. No. 5,031,119 another approach to inputting information into a palmtop computer is mentioned, that is, the use of a handwriting recognition system. However, no details concerning the operation of the handwriting recognition system and switching from one method of inputting to another are disclosed in this patent. A handwriting recognition system is disclosed in the patent application titled “Multiple Pen Stroke Character Set and Handwriting Recognition System with Immediate Response” filed by Hawkins et.al. on Jul. 1, 1994, Ser. No. 08/270,025. With a pen, the user writes in a handwriting input area successive predetermined strokes (e.g., resembling alphabetic letters) immediately recognised and displayed on the screen. It shall be noted that, unlike the keyboard emulator, the handwriting input area is usually located at a part of the screen not used for displaying information.

Still another approach is shown by Kuriyama et al. in U.S. Pat. No. 5,838,302 in which a combined input of typed and handwritten data is proposed. An important feature of inputting a handwritten data is the lack of any handwriting recognition system. The handwritten data is stored in memory as image data.

A palm-top computer device disclosed in U.S. Pat. No. 5,889,888 granted to Marianetti, II, et.al. titled “Method and Apparatus for Immediate Response Handwriting Recognition System that Handles Multiple Character Sets” issued on Mar. 30,1999 discloses a computer in which a display screen responds to a pen. In the lower part of the display screen two handwriting input areas are located for accepting strokes written by the user for inputting alphabetic characters and Arabic numerals, respectively. Additional input areas may be provided, e.g. for Cyrillic alphabet or Japanese character sets. An accepted stroke is recognized by handwriting recognition means as a character or numeral which is displayed on the screen. It shall be noted that the handwriting input areas are permanently designated areas labeled (or marked) on the screen.

A text written in one language may comprise letters and/or words from another language which may use another type of alphabet. Thus, in modern Russian language names, trademarks, etc. originating from the languages using Roman alphabet, are usually not transliterated into Russian. A user may, therefore, face with difficulties while inputting, say, a Russian text comprising words written in English. Marianetti, II, et.al. proposes defining an additional handwriting input area for Cyrillic letters. Introduction of an additional input area within a limited space of the display screen will inevitably lead to reducing the size of the input areas. However, an input area shall be large enough to allow the user to draw a clear stroke. Thus, the input areas reduced in size will certainly deteriorate the quality of recognition.

For inputting letters of another type of alphabet, it seems natural to use, in addition to the handwriting input areas, a keyboard emulator of the above-mentioned type. Also, the use of keyboard input in addition to handwriting input may be preferable in other applications, e.g. while editing a text comprising tables, mathematical formulas, etc. However, this is not convenient because the keyboard emulator takes quite a lot of screen space available for displaying information. Thus, a corresponding empty space on the screen shall be prepared before calling the keyboard. The space available for displaying information is thus substantially reduced. Further, the user has to swing from one area of the display screen to another while inputting information.

### BRIEF SUMMARY OF THE INVENTION

The object of the present invention is to provide a convenient method of inputting information into a computer device, a sticker keyboard and a computer device provided with this keyboard, wherein the user may alternatively input information either by writing predetermined strokes like characters and numerals in a handwriting input area, or by acting (using predetermined handwriting actions) on smaller input areas arranged on the sticker keyboard, wherein the screen space available for displaying information is not reduced and the user does not have to swing from one area of the display screen/digitizer pad to another while inputting information.

The idea of the invention is to use the space occupied on the display screen by the handwriting input areas which are permanently designated and marked and, therefore, not used for displaying information. Within this space smaller input areas operable in another mode of operation as keys of a keyboard may be additionally located, the smaller input areas being marked, e.g. with another colour to be visual simultaneously. Also, the invention provides an extension of functions of these keyboard keys. In other words, not only pressure onto a point (resulting in inputting a character) may be used, but also other handwriting actions, e.g. an upward or downward stroke across the key (resulting, e.g. in inputting the respective character in the upper case or activating a function). Otherwise, a special key would be needed for activating the upper case or a function. Thus, the number of the keys may be reduced. Furthermore, the invention provides means for automatically activating the desired mode of operation through identification of each inputted handwriting action.

According to one aspect of the invention, a keyboard for inputting information into a computer device comprising a display screen, a digitizer pad and at least one handwriting recognition system, is proposed, the keyboard comprising:

a sheet of material for attaching on a screen of a computer device, in which sheet are provided

a space allocated for a plurality of one or more first input areas adapted for accepting a first plurality of predetermined handwriting actions recognizable as a corresponding plurality of inputted characters and/or commands when the computer device is in its first mode of operation; and

a space allocated for a plurality of second input areas at least partially overlapping the space allocated for said plurality of one or more first input areas, each said second input area being adapted for accepting a second plurality of predetermined handwriting actions recognizable as a corresponding plurality of inputted characters and/or commands when the computer device is in its second mode of operation.

According to another aspect of the invention, a method of inputting information into a computer device is proposed, the method comprising the steps of:

a) providing a plurality of one or more first input areas adapted for accepting a first plurality of predetermined handwriting actions recognizable as a corresponding plurality of inputted characters and/or commands when the computer device is in its first mode of operation;

b) providing a plurality of second input areas at least partially occupying the space designated for said at least one first input area, each said second input area being adapted for accepting a smaller second plurality of predetermined handwriting actions recognizable as a corresponding plurality of inputted characters and/or commands when the computer device is in its second mode of operation;

c) accepting a predetermined handwriting action executed by the user in the desired input area;

d) identifying said handwriting action as belonging to the first or second plurality of predetermined handwriting actions and activating a corresponding, first or second, mode of operation;

e) recognising said handwriting action as a corresponding character or command; and

f) repeating steps (c), (d), and (e) for inputting a desired sequence of characters and/or commands.

The step of identifying said handwriting action as belonging to the first or second plurality of predetermined handwriting actions preferably includes:

defining one of the second input areas in which said stroke starts;

determining if the stroke extends beyond the limits of the input area; and

activating a corresponding mode of operation depending on whether the stroke extends beyond the limits of the input area or not.

According to another aspect of the invention, a method of inputting information into a computer device is proposed, the method comprising the steps of:

a) providing at least one first input area adapted for accepting a first plurality of predetermined handwriting actions recognizable as a corresponding plurality of inputted characters and/or commands when the computer device is in its first mode of operation;

b) providing smaller second input areas at least partially occupying the space designated for said at least one first input area, each said second input area being adapted for accepting a smaller second plurality of predetermined handwriting actions recognizable as a corresponding plurality of inputted characters and/or commands when the computer device is in its second mode of operation;

c) providing a sheet of material with marked said first input areas and said second input areas;

d) alternatively activating said first or second mode of operation;

e) accepting a predetermined handwriting action executed by the user in the desired input area;

f) recognising said predetermined handwriting action as a corresponding character or command;

g) repeating steps (e) and (f) for inputting a desired sequence of characters and/or commands. Preferably, the first plurality of predetermined handwriting actions includes strokes recognizable as alphabetic letters and Arabic numerals. Preferably, the second plurality of predetermined handwriting actions includes, but not limited to, a full stop, a straight upward stroke, a straight downward stroke, a stroke to the left, a stroke to the right, and any other simple movements of a stylus.

According to another aspect of the invention, a computer program product for use in a computer system is proposed, said computer program product comprising

a computer usable medium having computer readable program code means embodied thereon for inputting information into a computer device, said computer program code means comprising:

a) computer program code recognition means for causing a computer to accept a first plurality of predetermined handwriting actions inputted by one or more first input areas and recognize them as a corresponding plurality of characters and/or commands when the computer device is in its first mode of operation;

b) computer program code recognition means for causing a computer to accept a second plurality of predetermined handwriting actions inputted by second input areas at least partially overlapping said first plurality of one or more input areas and recognize them as a corresponding plurality of characters and/or commands when the computer device is in its second mode of operation;

c) computer program code identification means for causing a computer to identify said inputted handwriting actions as belonging to the first or second plurality of predetermined handwriting actions and activating a corresponding, first or second, mode of operation;

d) computer program code recognition means for causing a computer to recognize said handwriting action as a corresponding character or command; and

e) computer program code sequencing means for causing a computer to initiate sequentially the operation of the means (a), (b), (c) and (d) for inputting a desired sequence of characters and/or commands.

According to still another aspect of the invention, a computer device is proposed, the computer device comprising a display screen, a digitizer pad and at least one handwriting recognition system, said digitizer pad having at least one first input area adapted for accepting a first plurality of predetermined handwriting actions recognizable as a corresponding plurality of inputted characters and/or commands when the computer device is in its first mode of operation; and second input areas, each said second input area being adapted for accepting a smaller second plurality of predetermined handwriting actions recognizable as a corresponding plurality of inputted characters and/or commands when the computer device is in its second mode of operation; wherein said second input areas at least partially occupy the space designated for said at least one first input area.

The computer device preferably further comprises identification and activation means for identifying a handwriting action as belonging to said first or second plurality of predetermined handwriting actions and activating a corresponding, first or second, mode of operation.

Preferably, said identification and activation means include:

means for defining one of the second input areas in which said stroke starts;

means for determining if the stroke extends beyond the limits of the input area; and

means for activating a corresponding mode of operation depending on whether the stroke extends beyond the limits of the input area or not.

Preferably, the handwriting recognition system is operable for recognising the handwriting actions inputted through said first input areas, the computer device further comprising another handwriting recognition system for recognising the handwriting actions inputted through said second input areas.

Preferably, the display screen is at least partially combined with the digitizer pad, both said first and second input areas being located at the part of the display screen not used for displaying information.

Preferably, said first input area is adapted for accepting strokes recognizable as alphabetic letters, the computer device having another first input area adapted for accepting strokes recognizable as Arabic numerals.

Preferably, different functions may be activated by pressing the said second input areas for different predetermined periods.

Preferably, said second input areas are covered by a polymer film.

Preferably, said second input areas are arranged and marked as keyboard keys.

With the method and computer device of the invention, the user may alternatively input information either by writing predetermined strokes resembling letters and numerals, in a handwriting input area, or by acting (also using predetermined handwriting actions) on smaller input areas arranged as a keyboard. The user always operates within the same limited space and does not have to swing from one area of the display screen/digitizer pad to another while inputting information because the second input areas occupy the space designated for the first input area. This space is permanently designated and marked and, therefore, not used for displaying information. Thus, the screen space available for displaying information is not reduced.

### BRIEF DESCRIPTION OF THE SEVERAL VIEWS OF THE DRAWING

The objects, features and advantages of the present invention will be apparent from the following detailed description of the preferred embodiments of the invention with references to the following drawings.

FIG. 1 shows a computer device with a sticker keyboard marked over two first handwriting input areas.

FIG. 2 shows an enlarged schematic view of the sticker keyboard of FIG. 1.

FIG. 3 shows examples of the first and second pluralities of predetermined handwriting actions.

FIG. 4 shows a flowchart illustrating the operation of the identification and activation means.

FIGS. 5a-5e show examples of sticker keyboard layouts, including English language keyboards of different shape (FIGS. 5a-5c), German language layout (FIG. 5d) and Russian language layout (FIG. 5e).

### DETAILED DESCRIPTION OF THE INVENTION

In the following description, for purposes of explanation, specific nomenclature is set forth to provide a thorough understanding of the present invention. However, it will be apparent to one skilled in the art that these specific details are not required to practice the present invention. In other instances, well-known devices are shown in block diagram form to avoid obscuring the present invention.

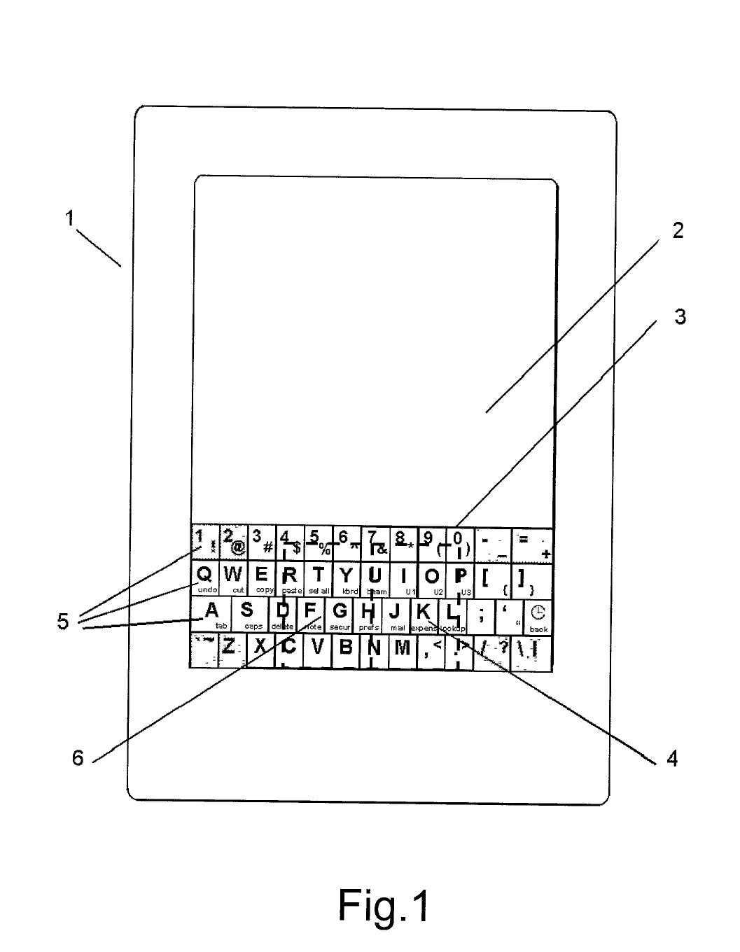

Referring now to FIG. 1, it will be seen that the exemplary embodiment of the claimed computer device is denoted as a whole by reference number 1. The computer device 1 comprises a display screen which is combined with (or, in other words, occupies the same area as,) a digitizer pad and, together with the latter, denoted by reference number 2. The computer device 1 is provided with a pen (not shown) for inputting information by acting on a “sticker keyboard”, or, a “stick-on keyboard” 3 at least partially covering the screen/digitizer pad 2. The handwriting actions performed by the user with the pen may include point-pressing (or putting a full stop) and drawing strokes of different size and shape. The screen/digitizer pad 2 comprises two first input areas 4 and 6 shown on a sticker keyboard 3 with dotted lines which are adapted for accepting a first plurality of predetermined handwriting actions (strokes). The input areas 4 and 6 are large enough to draw complex strokes like characters or numerals therein. Also, the sticker keyboard comprises a second plurality of smaller input areas 5 made in the form of keyboard keys arranged on a film sticker keyboard in a standard manner.

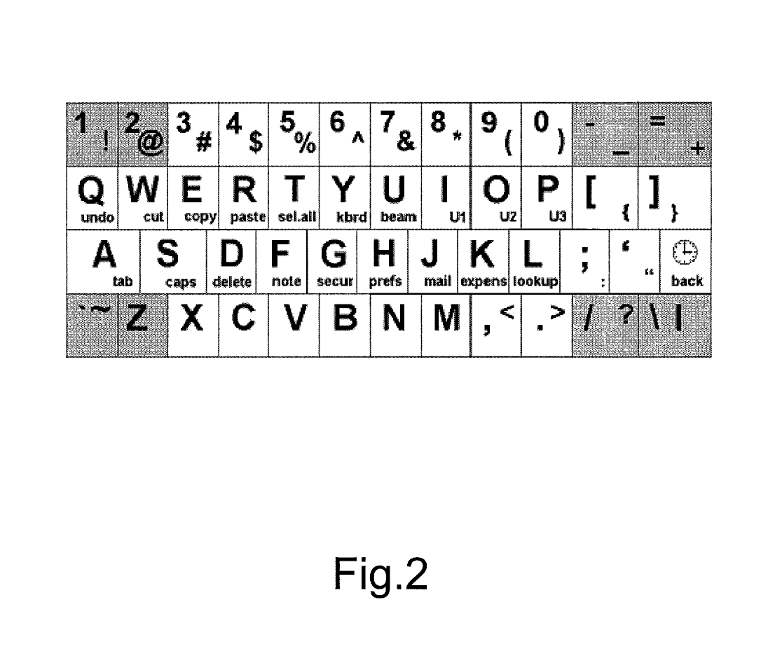

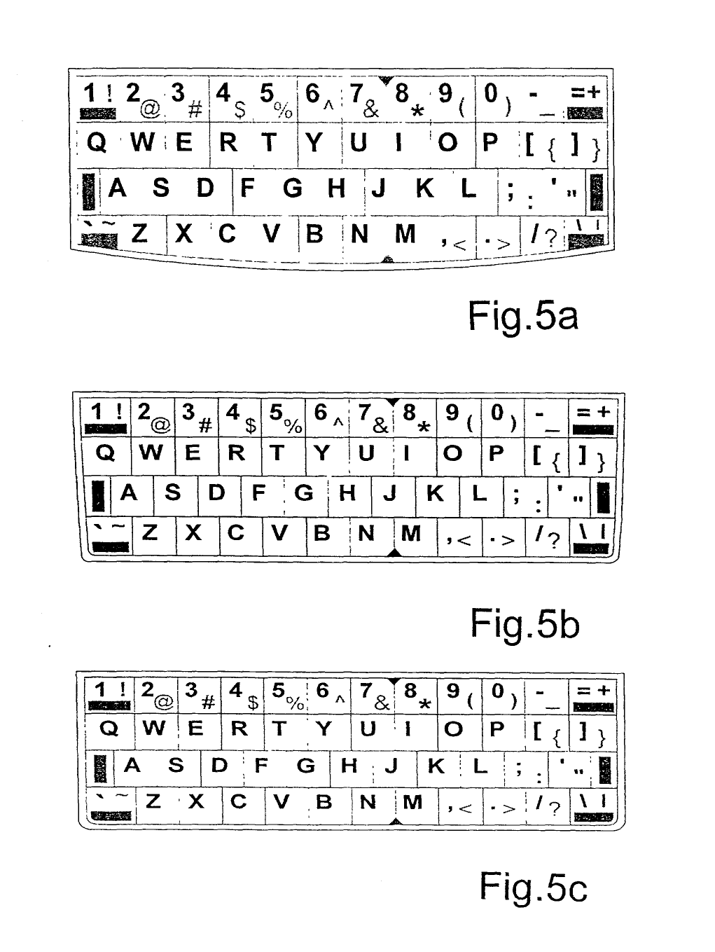

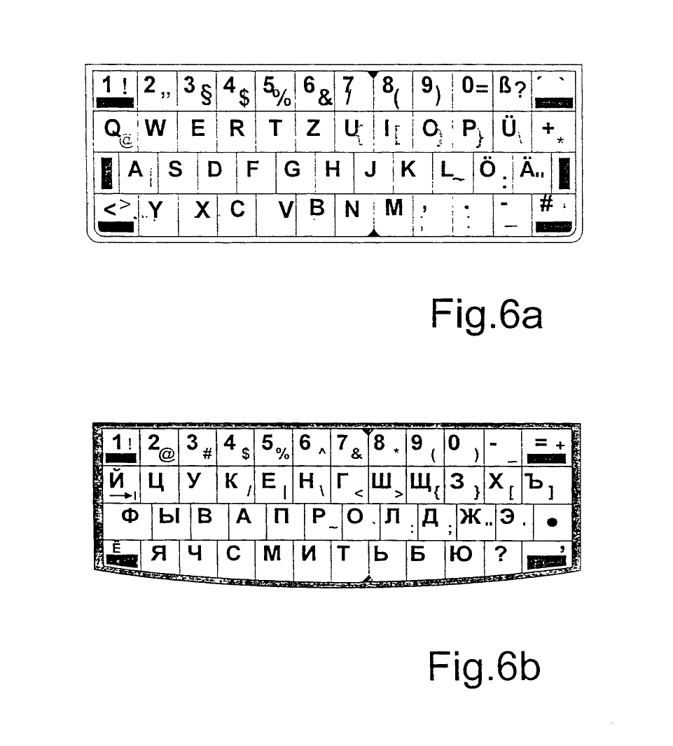

Example embodiments of the sticker keyboard 3 are shown in detail in FIG. 2 and also in FIGS. 5a-5c and FIGS. 6a-6b. The sticker comprises a sheet of material covering the first and second input areas provided on a computer screen.

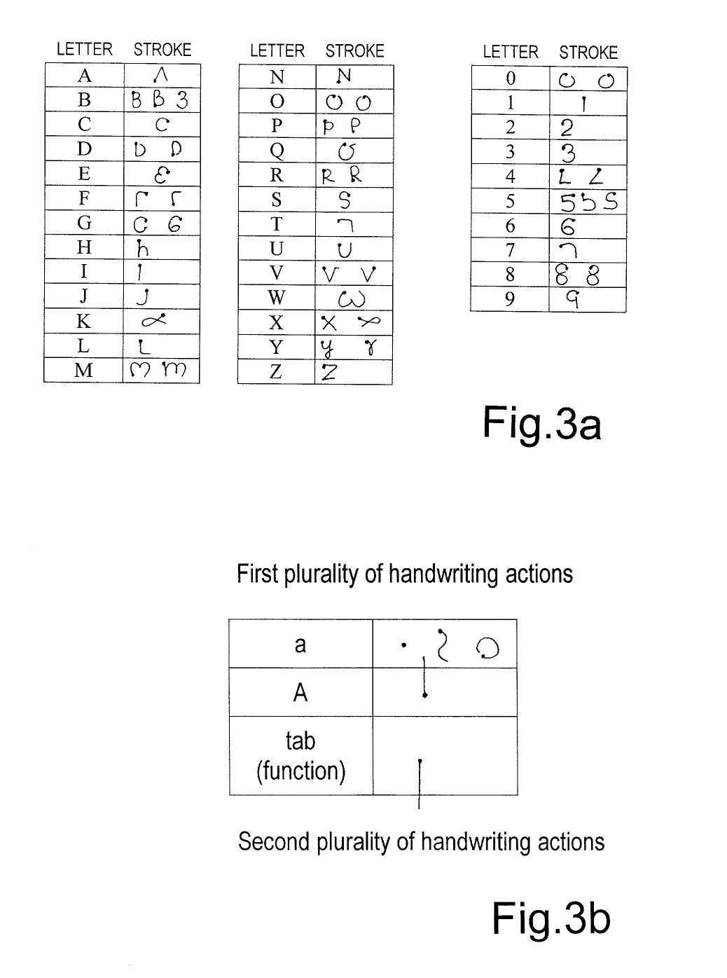

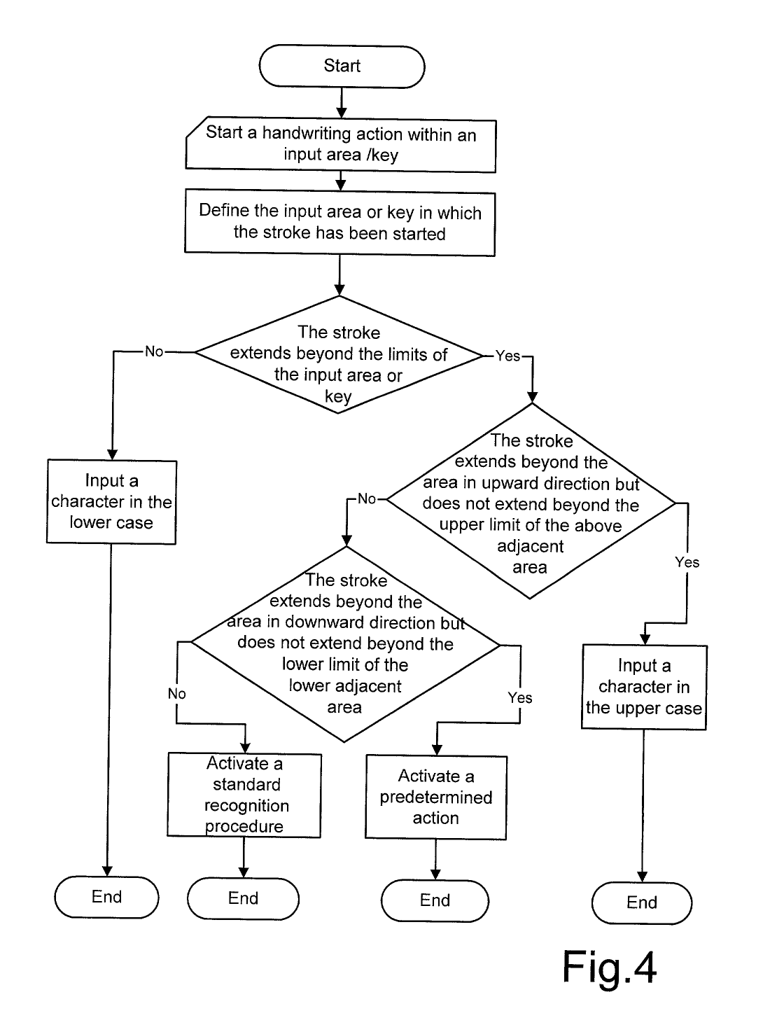

The first input areas may be marked in a dotted lines as shown in FIG. 1, or designated by two triangles of a different colour as shown in FIGS. 3-4, or they may be implicit and not marked on the sticker keyboard but mentioned in the user's manual as being located under the sticker.

In the present embodiment of the invention, the second input areas are separated on a sticker keyboard by thin lines and designated by indicating the corresponding characters and functions.

The sticker keyboard may be easily manufactured by various technological processes known in the art.

Preferably, the sticker keyboard is made of a polymeric film, such as vinyl, polyethylene, polyester, polyethylene vinyl co-polymers and other polymers known to be processed in a thin film. For example, a Silvinile film manufactured by Cartongraf (Italy) may be used for this purpose, preferably Bianco Opaco (Opaque) Removable.

The film may be formed to be electrostatic to adhere to the surface of a computer screen by electrostatic forces in the absence of an adhesive agent.

The sticker may also be inserted between the screen and the screen frame in case the computer device is marketed with a screen frame.

One more possibility is to make the sticker of an adhesive film manufactured in the form of a thin sheet of polymeric film having an adhesive layer applied on one side of it.

Special adhesive ready-to-use films may be purchased, or a suitable adhesive agent may be applied on the film, for example, by offset printing, or other methods well known for a specialist in the art. Non-tacky highly viscous non-volatile substances, for example, petrolatum, may also be used for this purpose.

The iput areas may be marked on the film, for example, by silk screen printing, or any printing technique suitable for marking a plurality of characters on a polymer film.

The first plurality of predetermined handwriting actions that may be inputted through input areas is presented in FIG. 5. It includes strokes like alphabetic characters to be inputted through left input area 6 and Arabic numerals to be inputted through right input area 4. In a first mode of operation of the computer device each stroke inputted in area 6 or 4 is immediately recognized by a known first handwriting recognition system incorporated in the computer 1 and displayed on the screen 2. The first input areas and the first plurality of predetermined handwriting actions are exactly like those described by Marianetti, II, et.al. It shall be also appreciated that the number and type of handwriting actions may be widely varied within the scope of the present invention.

The computer is adapted to have a second mode of operation in which second input areas 5 arranged as keyboard keys on the sticker keyboard 2 are activated. It shall be noted that keys/input areas 5 are not displayed on the screen because, as shown in FIG. 1, keys/input areas 5 are located over and near, input areas 6 and 4 occupying the space not used for displaying information. Keys/input areas 5 may be marked directly on the screen or, preferably, on a sticker keyboard 3 which can act additionally as a protection cover constituted by a polymer film which is placed over the input areas to protect the display screen from being damaged by the pen. Preferably, keys/input areas 5 are marked with another colour to be visible simultaneously with areas 6 and 4. To input a desired character, a key, i.e. a point within a corresponding input area/key 5, shall be pressed by a pen. Also, any stroke drawn by the user within an input area/key 5 will be interpreted as pressing a key. In other words, to input a desired character, the user shall place a full stop or draw a stroke within a desired input area/key 5.

In another embodiment, the keys are made of a larger size, wherein each key is marked with more than one character, whereby several characters may be inputted using the same key. A desired character may be recognized by predetermined manner of inputting. For example, if four characters are marked on the four corners of a same key, a stroke towards the respective corner will result in inputting the corresponding character.

Also, the invention provides an extension of functions of keyboard keys/input areas 5.

To input a character in the upper case, the user shall draw an upward stroke across a corresponding input area/key 5. This stroke shall extend beyond the predetermined limits in vertical and horizontal directions. The horizontal limit may be defined by the condition that the stroke shall not extend beyond the upper edge of an upper adjacent input area/key. The vertical limit may be defined by the condition that the stroke shall not cross imaginary vertical lines extending along the side edges of the input area/key in which the stroke has been started.

According to another embodiment of the invention, the user may switch the upper/lower cases by pressing a corresponding input area key in a different manner, for example, varying the duration of pressing. For example, a short pressure (e.g. for 0.1-0.2 seconds) would result in inputting a character in lower case, while the relatively extended pressure (e.g., for 0.5-0.6 seconds) would result in inputting a character in the upper case.

Alternatively, different functions may be activated by varying not only the duration of a stroke, but also the character of a effecting a stroke, for example, a stroke resembling double click of a standard key may be made by a pen in the desired input area.

To input a command activating a predetermined function, a downward stroke across a corresponding input area/key 5 shall be drawn by the user. This stroke shall extend beyond the limits of the input area/key 5 downwards from above, but shall not extend beyond the limits which may be defined in a similar way as described above with respect to the upward stroke. The full stop, various strokes within a key, for example, an upward stroke extending beyond the limits of the input area/key, and a downward stroke extending beyond the limits of the input area/key, a stroke to the left, a stroke to the right, and other strokes form a second plurality of handwriting actions. In FIG. 3, an example of the second plurality of handwriting actions is given relating to the key for inputting the letter “A” and the function “Tabulation” (Tab.) of the keyboard presented in FIG. 2. The same plurality of handwriting actions is applicable to any other key of the keyboard, respectively.

A further extension of functions of keyboard keys/input areas 5 is possible by using strokes of other directions and/or shapes. However, these strokes must not be too complex because it is hard to draw definitely a complex stroke in an area of small size. Due to the fact that the second plurality of handwriting actions consists of much more simple actions, a second handwriting recognition system for recognising the second plurality of handwriting actions is rather simple too. It does not have to analyze the shape of the stroke, it only determines, whether the stroke extends beyond the limits of a respective input area/key or not. In this example, the second handwriting recognition system is incorporated in the identification and activation means described below. However, the computer may be adapted to use the first handwriting recognition system for recognising the second plurality of handwriting actions, particularly in the case when it includes relatively complex strokes.

Alternatively, the functions of the second input areas may be extended by pressing keys, for example, Tab or Alt, specially reserved for switching the computer modes. Thus, each key may be used to input different characters. In an embodiment of the invention each mode of operation is activated by a special command inputted by the user. By inputting this command, the user may turn from one way of inputting to another.

In another preferred embodiment of the invention the computer device is provided with identification and activation means for identifying a handwriting action as belonging to said first or second plurality of predetermined handwriting actions and activating a corresponding, first or second, mode of operation. Said identification and activation means include means for defining one of the second input areas in which said stroke starts; means for determining if the stroke extends beyond the limits of the input area; and means for activating a corresponding mode of operation depending on whether the stroke extends beyond the predetermined limits or not.

The operation of the identification and activation means is evident from the flowchart presented in FIG. 4. As already mentioned, the second handwriting recognition system is incorporated in said identification and activation means. A “yes” in any decision block means that a handwriting action is identified as belonging to said first plurality. “No” in the last decision block means that a handwriting action is identified as belonging to said second plurality.

In FIGS. 5a-5c example embodiments of English language layout sticker keyboard are presented having different shapes to comply with the possible different shapes of a computer screen to be applied on. In FIG. 6a, a German language sticker keyboard is presented and in FIG. 6b, a Russian language sticker keyboard is presented.

It shall be appreciated that the entire specification and the accompanying drawings may be interpreted as illustrative only and not in the limiting sense. For example, many other embodiments of the identification and activation means may be designed. Further, in the described computer device the display screen responds to a pen. However, other interactive devices may be used for inputting handwriting actions. Also, various layouts and designs of a sticker keyboard may be proposed by those skilled in the art. Thus, various modifications and alterations may be made without departing from the scope and spirit of the present invention, which is defined only by the following claims.

I claime:

1. A method of inputting information into a computer device, the method comprising the steps of:
a) providing at least one first input area adapted for accepting a first plurality of predetermined handwriting actions recognizable as a corresponding plurality of inputted characters and/or commands when the computer device is in its first mode of operation;
b) providing second input areas at least partially occupying the space designated for said at least one first input area, each said second input area being adapted for accepting a smaller second plurality of predetermined handwriting actions recognizable as a corresponding plurality of inputted characters and/or commands when the computer device is in its second mode of operation;
c) accepting a predetermined handwriting action executed by the user in the desired input area;
d) identifying said handwriting action as belonging to said first or second plurality of predetermined handwriting actions and activating a corresponding, first or second, mode of operation;
e) recognizing said handwriting action as a corresponding character or command; and
f) repeating steps (c), (d), and (e) for inputting a desired sequence of characters and/or commands.

2. The method of claim 1, wherein said first plurality of predetermined handwriting actions includes strokes recognizable as alphabetic letters and Arabic numerals.

3. The method of claim 1 or 2, wherein said second plurality of predetermined handwriting actions includes, but not limited to, a full stop, a straight upward stroke, a straight downward stroke, a stroke to the right, a stroke to the left.

4. The method of any one of claims 1 to 3, wherein said step of identifying said handwriting action as belonging to the first or second plurality of predetermined handwriting actions includes:
determining one of the second input areas in which said stroke starts;
determining if the stroke extends beyond the limits of the input area; and
activating a corresponding mode of operation depending on whether the stroke extends beyond the limits of the input area or not.

5. A computer device comprising a display screen, a digitizer pad and at least one handwriting recognition system,
said digitizer pad having
a space allocated for at least one first input area adapted for accepting a first plurality of predetermined handwriting actions recognizable as a corresponding plurality of inputted characters and/or commands when the computer device is in its first mode of operation; and
a space allocated for second input areas being adapted for accepting a second plurality of predetermined handwriting actions recognizable as a corresponding plurality of inputted characters and/or commands when the computer device is in its second mode of operation; wherein said second input areas at least partially occupy the space allocated for said at least one first input area, wherein said second input areas are marked on a sheet of material applied on the screen, the computer device further comprising an identification and activation means for identifying a handwriting action as belonging to said first or second plurality of predetermined handwriting actions and activating a corresponding, first or second, mode of operation.

6. The computer device of claim 5, wherein said identification and activation means include:
means for determining one of the second input areas in which said stroke starts;
means for determining if the stroke extends beyond the limits of the input area; and
means for activating a corresponding mode of operation depending on whether the stroke extends beyond the limits of the input area or not.

7. The computer device of claim 5, wherein the handwriting recognition system is operable for recognizing the handwriting actions inputted through said first input areas, the computer device further comprising another handwriting recognition system for recognizing the handwriting actions inputted through said second input areas.

8. The computer device of claim 5, wherein the display screen is at least partially combined with the digitizer pad, both said first and second input areas being located at the part of the display screen not used for displaying information.

9. The computer device of claim 5, wherein said first input area is adapted for accepting strokes recognizable as alphabetic letters, the computer device having an additional first input area adapted for accepting strokes recognizable as Arabic numerals.

10. The computer device of claim 5, wherein said second input areas are covered by a polymer film.

11. The computer device of claim 10, wherein the polymer film overlaps said first input areas.

12. A computer device of claim 5, wherein said second input areas are arranged and marked as a keyboard.

13. A keyboard for inputting information into a computer device comprising a display screen, a digitizer pad and at least one handwriting recognition system, the keyboard comprising:
a sheet material for attaching on a screen of the said computer device, in which sheet are provided
a space allocated for plurality of one or more first input areas adapted for accepting a first plurality of predetermined handwriting actions recognizable as a corresponding plurality of inputted characters and/or commands when the computer device is in its first mode of operation; and
a space allocated for plurality of second input areas at least partially overlapping said plurality of one or more first input areas, each said second input area being adapted for accepting a second plurality of predetermined handwriting actions recognizable as a corresponding plurality of inputted characters and/or commands when the computer device is in its second mode of operation.

14. A keyboard according to claim 13, wherein the sheet material is a polymer film.

15. A keyboard according to claim 13, wherein the sheet material is a polymer film having a layer of adhesive material for securing the film to the screen of said computer device.

16. A keyboard according to claim 13, wherein the polymer film is made of polymer selected from the group including, but not limited to, polyethylene, polyethylene offset, vinyl, polyethylene vinyl copolymers, polyesters.

17. A keyboard according to claim 13, wherein the sheet material is of electrostatic film for securing the sheet to the screen of a computer device by electrostatic forces.

18. A keyboard according to claim 13, wherein the sheet material is secured to the screen of a computer device by a layer of non-tacky viscous non-volatile substance.

19. A keyboard according to claim 13, wherein a space allocated for the plurality of said one or more first input areas is marked by colour.

20. A keyboard according to claim 13, wherein the sheet is made of a material with a layer of phosphorescing material.

21. A computer program product for use in a computer device comprising a display screen, a digitizer pad and at least one handwriting recognition system, said computer program product comprising
a computer usable medium having computer readable program code means embodied thereon for inputting information into a computer device, said computer program code means comprising:
a) computer program code recognition means for causing a computer to accept a first plurality of predetermined handwriting actions inputted by one or more first input areas and recognize them as a corresponding plurality of characters and/or commands when the computer device is in its first mode of operation;
b) computer program code recognition means for causing a computer to accept a second plurality of predetermined handwriting actions inputted by smaller second input areas at least partially overlapping said first plurality of one or more input areas and recognize them as a corresponding plurality of characters and/or commands when the computer device is in its second mode of operation;
c) computer program code identification means for causing a computer to identify said inputted handwriting actions as belonging to the first or second plurality of predetermined handwriting actions and activating a corresponding, first or second, mode of operation;
d) computer program code recognition means for causing a computer to recognize said handwriting action as a corresponding character or command; and
e) computer program code sequencing means for causing a computer to initiate sequentially the operation of the means (a), (b), (c) and (d) for inputting a desired sequence of characters and/or commands.

22. A computer program product as claimed in claim 21, wherein said first plurality of predetermined handwriting actions includes strokes recognizable as alphabetic letters and Arabic numerals.

23. A computer program product as claimed in claim 21, wherein said second plurality of predetermined handwriting actions includes, but not limited to, a full stop, a straight upward stroke, a straight downward stroke, a stroke to the left, a stroke to the right.

24. A computer program product as claimed in claim 25, wherein said computer program code means for identifying said handwriting action as belonging to the first or second plurality of predetermined handwriting actions includes:
a computer program code means for determining one of the second input areas in which said stroke starts;
a computer program code means for determining if the stroke extends beyond the limits of the input area; and
a computer program code means for activating a corresponding mode of operation depending on whether the stroke extends beyond the limits of the input area or not.
